(19) United States
(12) Patent Application Publication
(10) Pub. No.: US 2021/0358079 A1
(43) Pub. Date: Nov. 18, 2021

(54) METHODS AND APPARATUS FOR ADAPTIVE RENDERING

(71) Applicant: QUALCOMM Incorporated, San Diego, CA (US)

(72) Inventors: Padmanabhan KOMANDURU V, Hyderabad (IN); Dileep MARCHYA, Hyderabad (IN); Srinivas PULLAKAVI, Kakinada (IN)

(21) Appl. No.: 16/874,607

(22) Filed: May 14, 2020

(51) Int. Cl. G06T 3/40; G06T 1/20; G06T 11/00

(52) U.S. Cl. CPC G06T 3/40; G06T 2210/36; G06T 11/00; G06T 1/20

(57) ABSTRACT

The present disclosure relates to methods and apparatus for display processing. The apparatus can monitor a rendering time for each of a plurality of layers in a display frame. The apparatus can also determine whether a rendering time of one or more layers is greater than a maximum rendering time threshold. The apparatus can also adjust a rendering resolution of the one or more layers when the rendering time of the one or more layers is greater than the maximum rendering time threshold. Moreover, the apparatus can reduce the rendering resolution of the one or more layers when the rendering time of the one or more layers is greater than the maximum rendering time threshold. Also, the apparatus can increase the rendering resolution of the one or more layers when the rendering time of the one or more layers is less than a minimum rendering time threshold.

### TECHNICAL FIELD

The present disclosure relates generally to processing systems and, more particularly, to one or more techniques for display or frame processing.

### INTRODUCTION

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A central processing unit (CPU) may control the operation of the GPU by issuing one or more graphics processing commands to the GPU. Modern day CPUs are typically capable of concurrently executing multiple applications, each of which may need to utilize the GPU during execution. A device that provides content for visual presentation on a display generally includes a GPU.

Typically, a GPU of a device is configured to perform the processes in a graphics processing pipeline. However, with the advent of wireless communication and smaller, handheld devices, there has developed an increased need for improved graphics processing.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a compositor, a frame compositor, a composer, a hardware composer, a frame composer, a frame processor, a display processor, a display processing unit (DPU), a CPU, or a GPU. The apparatus can monitor a rendering time for each of a plurality of layers in a display frame. The apparatus can also determine whether a rendering time of one or more layers is greater than a maximum rendering time threshold. Additionally, the apparatus can identify the one or more layers when the rendering time of the one or more layers is greater than the maximum rendering time threshold. The apparatus can also monitor a vertical synchronization (VSYNC) time period corresponding to the one or more layers when the rendering time of the one or more layers is greater than the maximum rendering time threshold. The apparatus can also adjust a rendering resolution of the one or more layers when the rendering time of the one or more layers is greater than the maximum rendering time threshold. Moreover, the apparatus can reduce the rendering resolution of the one or more layers when the rendering time of the one or more layers is greater than the maximum rendering time threshold. The apparatus can also reduce the rendering resolution of the one or more layers when the VSYNC time period corresponding to the one or more layers is greater than a maximum VSYNC threshold. The apparatus can also stop to adjust the rendering resolution of the one or more layers when the rendering time of the one or more layers is equal to a minimum rendering time threshold. Also, the apparatus can increase the rendering resolution of the one or more layers when the rendering time of the one or more layers is less than a minimum rendering time threshold. The apparatus can also increase the rendering resolution of the one or more layers when the rendering resolution of the one or more layers is less than a minimum resolution level.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example diagram of display or frame processing in accordance with one or more techniques of this disclosure.

FIG. 4 illustrates an example flowchart of an example method in accordance with one or more techniques of this disclosure.

### DETAILED DESCRIPTION

In order to avoid a jank for frame delay, a frame may need to be rendered by a VSYNC boundary. Also, if a frame is not rendered by the next VSYNC time, this may result in an occasional VSYNC extension. In these instances, the VSYNC boundary can be extended or lengthened to accommodate a rendering delay. Adaptive synchronization methods or rendering delays may be enabled if a GPU rendering rate cannot catch up to a high display frame rate. In some aspects, a continuous adaptive synchronization or VSYNC extension may cause the overall display refresh rate to be reduced. The problem with continuous adaptive synchronization or continuous rendering delays is that the application or display may not align with the newly extended VSYNC boundary. As such, the application or game may not align with the newly delayed panel refresh rate. This can defeat the purpose of having a high refresh rate display panel, such as by limiting the application or game play experience of a high refresh rate. Aspects of the present disclosure can include adaptive synchronization methods that can align a reduced display refresh rate with the display refresh rate of an application or game. For instance, aspects of the present disclosure can include an adaptive display frame scheduler that may not temporarily reduce the display refresh rate, and then allow for an adjustment in the display refresh rate so as to continue aligning the panel refresh rate with the application or game. Aspects of the present disclosure can include an adaptive game rendering model in which the rendering resolution is decreased in small steps based on an extended VSYNC duration until the extension drops to a minimum level. So the present disclosure can temporarily allow the display refresh rate to decrease until the GPU rendering rate catches up. Then the present disclosure can adjust or increase the display refresh rate so that it may not be continuously decreased.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

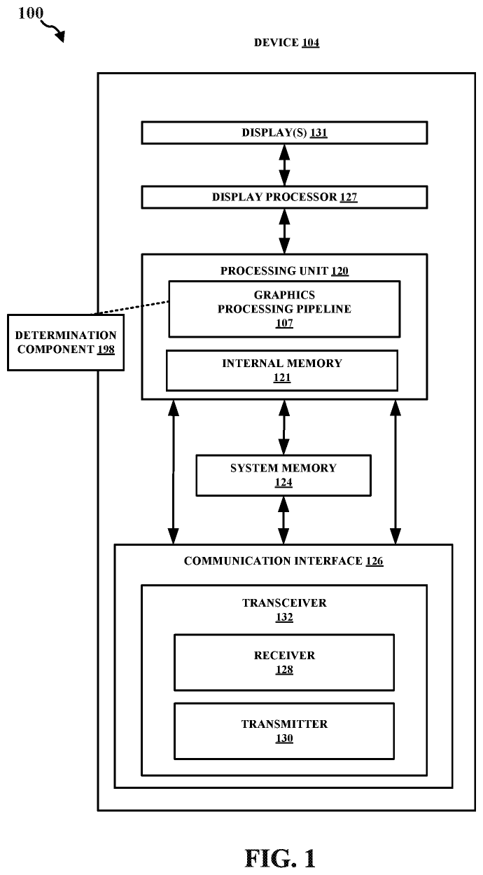

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, and a system memory 124. In some aspects, the device 104 can include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this can be referred to as split-rendering.

The processing unit 120 may include an internal memory 121. The processing unit 120 may be configured to perform graphics processing, such as in a graphics processing pipeline 107. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120, such as system memory 124, may be accessible to the processing unit 120. For example, the processing unit 120 may be configured to read from and/or write to external memory, such as the system memory 124. The processing unit 120 may be communicatively coupled to the system memory 124 over a bus. In some examples, the processing unit 120 may be communicatively coupled to each other over the bus or a different connection.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the graphics processing pipeline 107 may include a determination component 198 configured to monitor a rendering time for each of a plurality of layers in a display frame. The determination component 198 can also be configured to determine whether a rendering time of one or more layers is greater than a maximum rendering time threshold. The determination component 198 can also be configured to identify the one or more layers when the rendering time of the one or more layers is greater than the maximum rendering time threshold. The determination component 198 can also be configured to monitor a vertical synchronization (VSYNC) time period corresponding to the one or more layers when the rendering time of the one or more layers is greater than the maximum rendering time threshold. The determination component 198 can also be configured to adjust a rendering resolution of the one or more layers when the rendering time of the one or more layers is greater than the maximum rendering time threshold. The determination component 198 can also be configured to reduce the rendering resolution of the one or more layers when the rendering time of the one or more layers is greater than the maximum rendering time threshold. The determination component 198 can also be configured to reduce the rendering resolution of the one or more layers when the VSYNC time period corresponding to the one or more layers is greater than a maximum VSYNC threshold. The determination component 198 can also be configured to stop to adjust the rendering resolution of the one or more layers when the rendering time of the one or more layers is equal to a minimum rendering time threshold. The determination component 198 can also be configured to increase the rendering resolution of the one or more layers when the rendering time of the one or more layers is less than a minimum rendering time threshold. The determination component 198 can also be configured to increase the rendering resolution of the one or more layers when the rendering resolution of the one or more layers is less than a minimum resolution level.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, can be performed using other components (e.g., a CPU), consistent with disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit that indicates which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

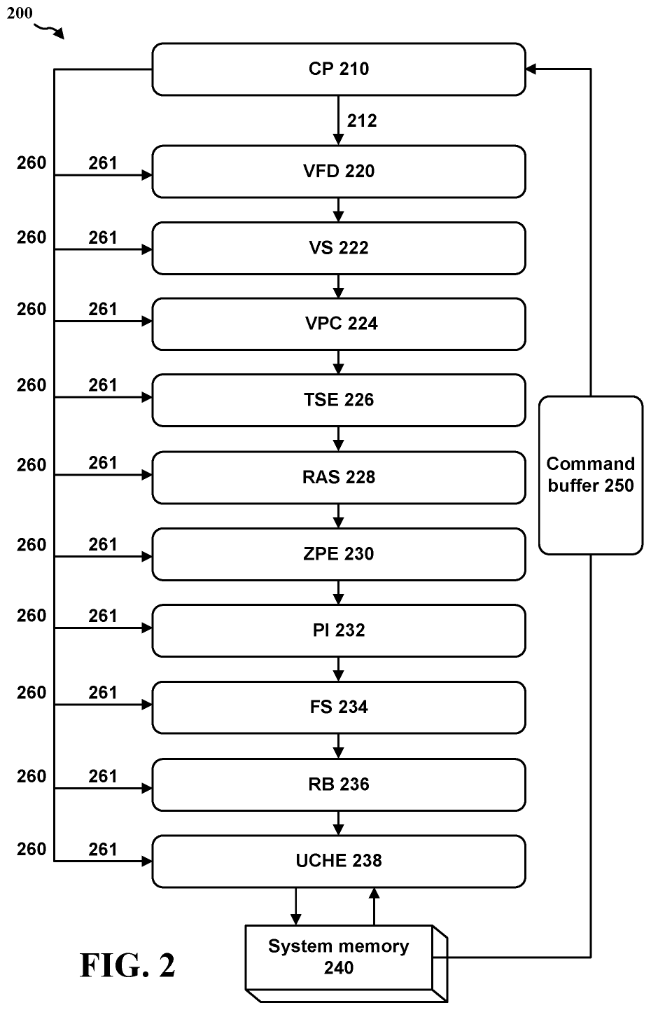

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can be structured in the following manner: context register of context N, draw call(s) of context N, context register of context N+1, and draw call(s) of context N+1.

Aspects of mobile devices or smart phones can utilize buffer mechanisms to distribute or coordinate a buffer between an application rendering side of the device, e.g., a GPU or CPU, and a display or composition side of the device, e.g., a display engine. For instance, some mobile devices can utilize a buffer queue mechanism to distribute or coordinate a buffer between an application rendering side and a display or composition side, which can include a buffer compositor or a hardware composer (HWC). In some aspects, the application rendering side can be referred to as a producer, while the display or composition side can be referred to as a consumer. Additionally, a synchronization divider or fence can be used to synchronize content between the application rendering side and the display or composition side. Accordingly, a fence can be referred to as a synchronization divider, and vice versa.

A variety of factors can be performance indicators for display processing between an application rendering side and a display or composition side. For instance, frames per second (FPS) and janks, i.e., delays or pauses in frame rendering or composition, are key performance indicators (KPI). In some aspects, a jank can be a perceptible pause in the rendering of a software application's user interface. Both FPS and janks are KPIs in game performance and/or device display capability. In some applications, janks can be the result of a number of factors, such as slow operations or poor interface design. In some instances, a jank can also correspond to a change in the refresh rate of the display at the device. Janks are important to gaming applications because if the display fresh latency is not stable, this can impact the user experience. Accordingly, some aspects of the mobile gaming industry are focused on reducing janks and increasing FPS.

Application can run at a variety of different FPS modes. In some aspects, applications can run at 30 FPS mode. In other aspects, applications can run at different FPS modes, e.g., 20 or 60 FPS. Aspects of the present disclosure can include a current frame latency time, which can refer to the time difference between when a previous frame completes being displayed and when a current frame completes being displayed. The frame latency time can also refer to the time between successive refreshing frames. The frame latency time can also be based on a frame rate. For instance, the frame latency time for each frame can be 33.33 ms (e.g., corresponding to 30 FPS), 16.67 ms (e.g., corresponding to 60 FPS), or 50 ms (e.g., corresponding to 20 FPS).

Jank reduction technology can be utilized in a number of different scenarios. For instance, slow frames, e.g., frames under 30 FPS, may optimize janks reduction differently than fast frames. For example, there may be frame pacing issues for frames under 30 FPS, which may utilize a different janks reduction technology than faster frames. In some aspects, different mechanisms or designs may have the ability to detect janks. Also, once janks are detected, other mechanisms can be triggered. For example, a compositor can be directly triggered to bypass a vertical synchronization (VSYNC) time in order to avoid janks. In some aspects, the threshold of the janks reduction technology may be platform dependent, which may need certain tuning efforts.

As indicated herein, if a frame takes too long to be rendered and is not ready for transmission to a display at a scheduled VSYNC time, this can result in a delayed frame display time and a corresponding jank. As such, janks can be the result of a delayed frame rendering. In some aspects, a frame buffer or buffer queue can queue frames waiting to be sent to the display. If a frame takes too long to be rendered, then the frame may not be consumed or sent to the buffer queue by the scheduled VSYNC time.

In some aspects, a compositor consume the frame or help send the frame buffer to the display. If the renderer takes too long to render a frame, then the compositor may be delayed in consuming the frame, so the frame will be delayed in being transmitted to the display. As such, a delay in rendering can cause a resulting delay in frame consumption or display transmission. In some aspects, if a frame has not finished rendering by a scheduled VSYNC time, then the frame will not be consumed by the composer until the next VSYNC time. In these aspects, if there are no frames in the buffer queue, then the compositor may not be triggered to consume the frame. As the frame is not consumed, this can result in a jank.

In display or frame processing, the display refresh rate can vary between the type of display panel, e.g., a 60 Hz, 90 Hz, or 120 Hz display panel. Also, a GPU rendering load can be increased when there are an increased amount of frames to be rendered, e.g., when there is a high refresh rate. For instance, high refresh rate panels can have a higher GPU rendering load compared to low refresh rate panels. For example, for a 120 Hz panel, there may be 8.33 ms to display the frame without a delay or jank. So for a high intensity application or game, the GPU rendering load may be too high to consistently render within a vertical synchronization (VSYNC) boundary. In these cases, there may be frame drops or janks.

In order to avoid frame drops or janks, adaptive synchronization methods or processes, e.g., Qsync, can be adopted. Adaptive synchronization methods can synchronize the display panel refresh to the GPU render rate, so that frames are displayed the moment they are rendered. This can occur if the frame rendering is not completed within the VSYNC boundary.

In adaptive synchronization methods, the VSYNC boundary can be extended or stretched until the GPU completes the frame rendering. For example, for a 120 Hz panel, the VSYNC boundary can be extended from 8.33 ms to 10 ms. This can help to accommodate any delays in the GPU frame rendering or any new frame updates. In some instances, once the GPU frame rendering is completed, the adaptive synchronization can be signaled, and the frames can be rendered and displayed at a slight delay, e.g., 1 or 2 ms. This can be a helpful mechanism in ensuring a jank-free or tear-free game play when there are occasional rendering delays.

However, there can be continuous rendering delays due to an excessive GPU rendering load. For example, this can be caused by high frame rates, e.g., 90 or 120 fps. So the GPU may not be capable of a 120 Hz frame rate with a corresponding 8.33 ms rendering rate, which can cause a continuous rendering delay. This can also be caused by GPU throughput limitations. For instance, this can be the case on value tier chipsets.

When continuous adaptive synchronization methods are enabled, the VSYNC can be extended or stretched continuously. Also, the display refresh rate can be limited to the GPU rendering rate, which can drop the display refresh rate, e.g., drop from 120 fps to 100 fps. So a continuous VSYNC extension or stretch may cause the overall frame rate to be reduced. Additionally, each application or game may not align to the adjusted refresh rate, which may potentially defeat the purpose of switching to a high refresh rate. So continuous adaptive synchronization due to GPU throughput limitations can decrease the application or game play experience. This may defeat the purpose of having a high refresh rate display panel.

As indicated herein, if a GPU rendering rate cannot catch up to a high display frame rate, adaptive synchronization methods or rendering delays may be enabled. As further indicated herein, a frame may need to be rendered by the next VSYNC time in order to avoid a jank. If a frame is not rendered by the next VSYNC time, this may result in an occasional VSYNC extension. In these instances, the VSYNC boundary can be extended or lengthened to accommodate a rendering delay. The DPU can increase the VSYNC time, so the GPU can catch up and render the frame fast enough. By doing so, the GPU rendering rate may catch up to a high display frame rate. By delaying or extending the VSYNC boundary, the amount of rendering delays or janks can be reduced.

In some aspects, the continuous adaptive synchronization or VSYNC extension may cause the overall display refresh rate to be reduced. So occasional adaptive synchronization or VSYNC extension may be fine, but continuous adaptive synchronization or VSYNC extension may cause the display refresh rate to be dropped. As such, if there are continuous rendering delays, due to the GPU not rendering fast enough, then the DPU may extend or delay the next VSYNC time continuously. In some aspects, the DPU can modify the VSYNC duration to accommodate any GPU rendering delays. So the GPU can render the frame, the DPU can modify the VSYNC boundary or alignment with the rendering rate, and then the DPU can send the frame to the display panel. If the GPU is not performing at a fast enough rendering rate, the DPU can extend the VSYNC boundary, so the actual refresh rate is lower than the panel refresh rate for the application or game.

The problem with continuous adaptive synchronization or continuous rendering delays is that the application or display may not align with the newly extended VSYNC boundary. So because of the extended VSYNC, the game or display may not be aligned to the actual display refresh rate, which is lengthened due to the continuous adaptive synchronization. As such, the application or game may not align with the newly delayed panel refresh rate. This can defeat the purpose of having a high refresh rate display panel, such as by limiting the application or game play experience of a high refresh rate. Accordingly, there is a present need for adaptive synchronization methods that can align a reduced display refresh rate with the display refresh rate of an application or game.

Aspects of the present disclosure can include adaptive synchronization methods that can align a reduced display refresh rate with the display refresh rate of an application or game. For instance, aspects of the present disclosure can include an adaptive display frame scheduler that may temporarily reduce the display refresh rate, and then allow for an adjustment in the display refresh rate, so as to continue aligning the panel refresh rate with the application or game. Aspects of the present disclosure can include an adaptive game rendering model in which the rendering resolution is decreased in small steps based on an extended VSYNC duration until the extension drops to a minimum level. So the present disclosure can temporarily allow the display refresh rate to decrease until the GPU rendering rate catches up. Then the present disclosure can adjust or increase the display refresh rate so that it may not be continuously decreased.

Additionally, the present disclosure can take steps to reduce the gap between the display refresh rate and the GPU rendering time. For instance, if there is a 120 Hz panel with a frame rendering time of 8.33 ms, the GPU may take 10 ms to render a frame. The present disclosure can reduce the 1.67 ms gap between the GPU rendering time and the display refresh rate, such as by temporarily extending the VSYNC boundary.

Aspects of the present disclosure can include a number of different steps or processes to implement an adaptive display frame scheduler. The present disclosure can include a CPU algorithm to perform this reduction in the GPU rendering rate and the display refresh rate. For instance, aspects of the present disclosure can monitor a frame rendering time across all layers inside a compositor. So the present disclosure can monitor the frame rendering time across all the layers in a display frame or composition layers.

Aspects of the present disclosure can identify one or more layers which are attributing to a consistent VSYNC extension or stretch. Reducing the rendering size for such layers may reduce the GPU rendering time, which can minimize and/or eliminate the VSYNC stretch. So the present disclosure can identify one or more layers in the display or composition that are contributing to the delayed GPU rendering rate, or the gap between the GPU rendering rate and the display refresh rate. These identified layers may be causing a heavy rendering load on the GPU.

Moreover, aspects of the present disclosure can adjust or reduce the frame rendering resolution size or window size for the identified layers inside a compositor over a period of time in small steps. By doing so, the resolution quality change for these layers may not be too abrupt to be detectable or noticeable. The frame rendering resolution size or window size is a resolution of a layer to be rendered, so reducing the window size may result in a lower rendering resolution. So if the resolution size is 1920×1080, and the GPU has an increased rendering load, the present disclosure can reduce the resolution size gradually, e.g., by 5 pixels at a time, in order to reduce the workload at a GPU. For example, the present disclosure can reduce the resolution size from 1920×1080 to 1915×1075. As the frame rendering resolution size can be gradually reduced, the GPU workload may experience a corresponding gradual reduction.

As indicated herein, the present disclosure can reduce the frame rendering resolution size for identified display layers, which can reduce the workload on the GPU. This can gradually reduce the VSYNC boundary extension. The frame rendering resolution can be reduced in small steps, so the frame rendering quality may not be noticeably affected. So by reducing the rendering size of layers gradually in small steps, a reduction in resolution quality may not be easily discernable. Aspects of the present disclosure can reduce the rendering resolution size of display layers until the GPU rendering rate catches up with the display refresh rate. So for 120 fps, if the GPU takes 10 ms to render a frame, the rendering size may be slowly reduced until the GPU can take 8.33 ms to render a frame.

In some aspects, layer scaling to a destination resolution may be performed by the DPU hardware at the time of composition. Because a frame rendering resolution is reduced, and the panel resolution is constant, the DPU can be utilized to upscale the rendered frame back to the size of the panel resolution. As mentioned above, the DPU can include a number of components, such as a compositor.

Aspects of the present disclosure can also monitor the VSYNC period or VSYNC extension period and continue reducing the frame rendering resolution size until the VSYNC extension reaches a minimum level and/or a resolution quality is above a threshold level. After the GPU workload is reduced, there may be no more need to extend the VSYNC period. The present disclosure can also monitor the VSYNC extension period until it reaches a minimum level. Also, the resolution quality may be maintained above a threshold level. So the present disclosure can balance the reduction of the VSYNC boundary, and have a minimal impact on the resolution quality. Once the resolution quality reaches or extends below a threshold level, the present disclosure can stop reducing the frame rendering resolution size.

Aspects of the present disclosure can also continue monitoring the frame rendering time and reverse the rendering size change in small steps when the rendering time is reduced. So the present disclosure can increase the frame rendering resolution size if the frame rendering resolution size is below a minimum frame resolution quality level. The frame rendering resolution size can be increased gradually if the GPU workload can handle the increase. As such, aspects of the present disclosure can maintain a certain quality level for a rendering resolution.

Aspects of the present disclosure can implement an adaptive display frame scheduler on a number of different applications or games, which can include a number of advantages or benefits. For instance, the present disclosure can reduce the amount of VSYNC boundary extension for applications or games by gradually reducing the frame rendering resolution size. For example, the present disclosure can gradually reduce the frame rendering resolution size, e.g., from 1440×2560 to 1080×1920, and achieve a corresponding reduction in the VSYNC boundary extension.

For a frame rendering resolution of 1440×2560, the panel resolution ratio can be 1.0×, the VSYNC extension percentage can be 21.36%, and the final frame rate can be 70.77. For a frame rendering resolution 1368×2432, the panel resolution ratio can be 0.95×, the VSYNC extension percentage can be 16.89%, and the final frame rate can be 74.80. Further, for a frame rendering resolution 1296×2304, the panel resolution ratio can be 0.90×, the VSYNC extension percentage can be 12.44%, and the final frame rate can be 78.80. For a frame rendering resolution 1224×2176, the panel resolution ratio can be 0.85×, the VSYNC extension percentage can be 9.55%, and the final frame rate can be 81.41. Moreover, for a frame rendering resolution 1152×2048, the panel resolution ratio can be 0.80×, the VSYNC extension percentage can be 3.24%, and the final frame rate can be 87.08. For a frame rendering resolution 1080×1920, the panel resolution ratio can be 0.75×, the VSYNC extension percentage can be 0%, and the final frame rate can be 90.00.

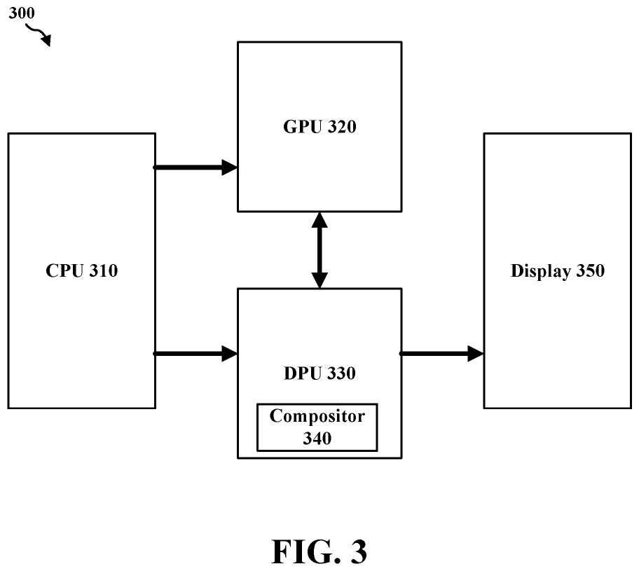

FIG. 3 illustrates diagram 300 in accordance with one or more techniques of this disclosure. More specifically, diagram 300 includes components of display or frame processing for adaptive rendering. As shown in FIG. 3, diagram 300 includes central processing unit (CPU) 310, graphics processing unit (GPU) 320, display processing unit (DPU) 330, compositor 340, and display 350. FIG. 3 illustrates the communication of each of these components during display or frame processing, such as for adaptive rendering.

As shown in FIG. 3, each of the components can communicate with one or more additional components. For instance, the CPU 310 can communicate with the GPU 320, as well as communicate with the DPU 330. Additionally, the GPU 320 and the DPU 330 can communicate with each another. Moreover, the DPU 330 can communicate with the display 350. In some aspects, the DPU 330 can include the compositor 340.

As shown in FIG. 3, aspects of the present disclosure can include a number of different techniques for adaptive rendering. For instance, aspects of the present disclosure, e.g., CPUs, DPUs, GPUs compositors, hardware composers, or frame processors, herein, can include a number of components for adaptive rendering. CPUs, DPUs, and GPUs herein, e.g., CPU 310, GPU 320, and DPU 330, can monitor a rendering time for each of a plurality of layers in a display frame, e.g., display 350. CPUs herein can also determine whether a rendering time of one or more layers of the plurality of layers is greater than a maximum rendering time threshold. Additionally, CPUs and DPUs herein can identify the one or more layers when the rendering time of the one or more layers is greater than the maximum rendering time threshold. In some aspects, the plurality of layers can be composed at a compositor, e.g., compositor 340.

CPUs and DPUs herein can also monitor a vertical synchronization (VSYNC) time period corresponding to the one or more layers when the rendering time of the one or more layers is greater than the maximum rendering time threshold. CPUs and GPUs herein can also adjust a rendering resolution of the one or more layers when the rendering time of the one or more layers is greater than the maximum rendering time threshold.

Moreover, CPUs and GPUs herein can reduce the rendering resolution of the one or more layers when the rendering time of the one or more layers is greater than the maximum rendering time threshold. In some aspects, the rendering resolution of the one or more layers may be reduced until the rendering time of the one or more layers is equal to a minimum rendering time threshold. Also, the rendering resolution of the one or more layers may be reduced until the rendering resolution of the one or more layers is equal to a minimum resolution level.

CPUs and GPUs herein can also reduce the rendering resolution of the one or more layers when the VSYNC time period corresponding to the one or more layers is greater than a maximum VSYNC threshold. In some aspects, the rendering resolution of the one or more layers may be reduced until the VSYNC time period is less than the maximum VSYNC threshold. Moreover, the VSYNC time period may be equal to a difference between a first VSYNC time and a second VSYNC time. In some instances, the VSYNC time period may correspond to the maximum rendering time threshold.

CPUs and GPUs herein can also stop to adjust the rendering resolution of the one or more layers when the rendering time of the one or more layers is equal to a minimum rendering time threshold. Also, CPUs and GPUs herein can increase the rendering resolution of the one or more layers when the rendering time of the one or more layers is less than a minimum rendering time threshold. CPUs and GPUs herein can also increase the rendering resolution of the one or more layers when the rendering resolution of the one or more layers is less than a minimum resolution level.

In some aspects, an increase in a GPU workload for the one or more layers may correspond to an increase in the rendering time of the one or more layers. Also, the rendering resolution of the one or more layers may correspond to a window size of the one or more layers. In some instances, the rendering resolution of the one or more layers may be adjusted by a graphics processing unit (GPU).

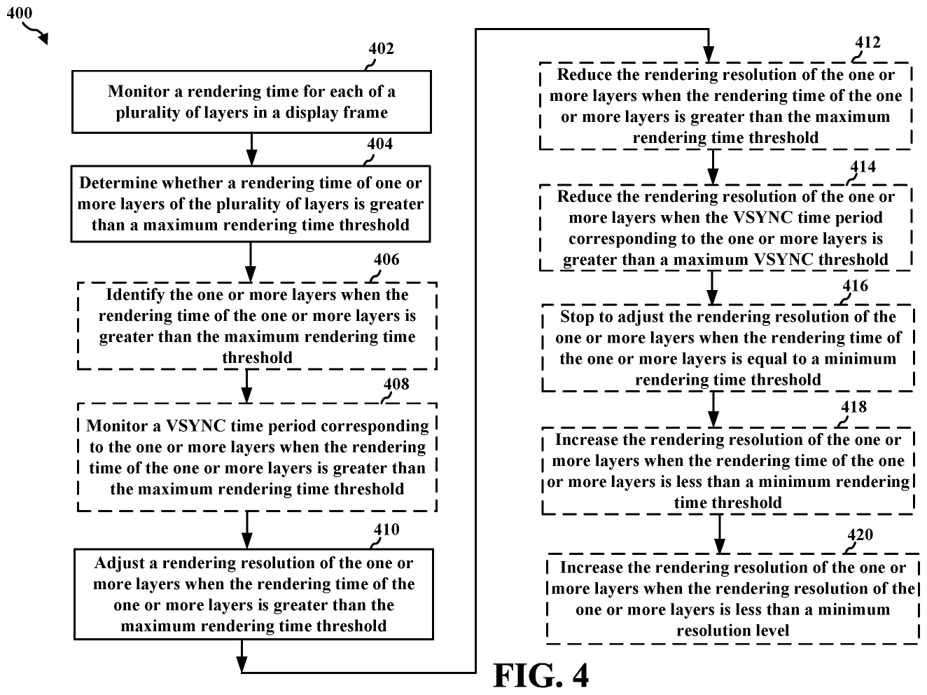

FIG. 4 illustrates an example flowchart 400 of an example method in accordance with one or more techniques of this disclosure. The method may be performed by an apparatus, e.g., a CPU, a GPU, a DPU, a compositor, a frame compositor, a composer, a hardware composer, a frame composer, a frame processor, a display processor, or an apparatus for frame or graphics processing.

At 402, the apparatus can monitor a rendering time for each of a plurality of layers in a display frame, as described in connection with the examples in FIG. 3. At 404, the apparatus can determine whether a rendering time of one or more layers is greater than a maximum rendering time threshold, as described in connection with the examples in FIG. 3. At 406, the apparatus can identify the one or more layers when the rendering time of the one or more layers is greater than the maximum rendering time threshold, as described in connection with the examples in FIG. 3.

At 408, the apparatus can monitor a vertical synchronization (VSYNC) time period corresponding to the one or more layers when the rendering time of the one or more layers is greater than the maximum rendering time threshold, as described in connection with the examples in FIG. 3. At 410, the apparatus can adjust a rendering resolution of the one or more layers when the rendering time of the one or more layers is greater than the maximum rendering time threshold, as described in connection with the examples in FIG. 3.

At 412, the apparatus can reduce the rendering resolution of the one or more layers when the rendering time of the one or more layers is greater than the maximum rendering time threshold, as described in connection with the examples in FIG. 3. In some aspects, the rendering resolution of the one or more layers may be reduced until the rendering time of the one or more layers is equal to a minimum rendering time threshold, as described in connection with the examples in FIG. 3. Also, the rendering resolution of the one or more layers may be reduced until the rendering resolution of the one or more layers is equal to a minimum resolution level, as described in connection with the examples in FIG. 3.

At 414, the apparatus can reduce the rendering resolution of the one or more layers when the VSYNC time period corresponding to the one or more layers is greater than a maximum VSYNC threshold, as described in connection with the examples in FIG. 3. In some aspects, the rendering resolution of the one or more layers may be reduced until the VSYNC time period is less than the maximum VSYNC threshold, as described in connection with the examples in FIG. 3. Moreover, the VSYNC time period may be equal to a difference between a first VSYNC time and a second VSYNC time, as described in connection with the examples in FIG. 3. In some instances, the VSYNC time period may correspond to the maximum rendering time threshold, as described in connection with the examples in FIG. 3.

At 416, the apparatus can stop to adjust the rendering resolution of the one or more layers when the rendering time of the one or more layers is equal to a minimum rendering time threshold, as described in connection with the examples in FIG. 3. At 418, the apparatus can increase the rendering resolution of the one or more layers when the rendering time of the one or more layers is less than a minimum rendering time threshold, as described in connection with the examples in FIG. 3. At 420, the apparatus can increase the rendering resolution of the one or more layers when the rendering resolution of the one or more layers is less than a minimum resolution level, as described in connection with the examples in FIG. 3.

In some aspects, an increase in a GPU workload for the one or more layers may correspond to an increase in the rendering time of the one or more layers, as described in connection with the examples in FIG. 3. Also, the rendering resolution of the one or more layers may correspond to a window size of the one or more layers, as described in connection with the examples in FIG. 3. In some instances, the rendering resolution of the one or more layers may be adjusted by a graphics processing unit (GPU), as described in connection with the examples in FIG. 3.

In one configuration, a method or apparatus for graphics processing is provided. The apparatus may be a compositor, a frame compositor, a composer, a hardware composer, a frame composer, a frame processor, a display processor, a display processing unit (DPU), a CPU, a GPU, or an apparatus for frame or graphics processing. In one aspect, the apparatus may be the processing unit 120 within the device 104, or may be some other hardware within device 104 or another device. The apparatus may include means for monitoring a rendering time for each of a plurality of layers in a display frame. The apparatus may also include means for determining whether a rendering time of one or more layers of the plurality of layers is greater than a maximum rendering time threshold. The apparatus may also include means for adjusting a rendering resolution of the one or more layers when the rendering time of the one or more layers is greater than the maximum rendering time threshold. The apparatus may also include means for reducing the rendering resolution of the one or more layers when the rendering time of the one or more layers is greater than the maximum rendering time threshold. The apparatus may also include means for increasing the rendering resolution of the one or more layers when the rendering time of the one or more layers is less than a minimum rendering time threshold. The apparatus may also include means for increasing the rendering resolution of the one or more layers when the rendering resolution of the one or more layers is less than a minimum resolution level. The apparatus may also include means for identifying the one or more layers when the rendering time of the one or more layers is greater than the maximum rendering time threshold. The apparatus may also include means for stop adjusting the rendering resolution of the one or more layers when the rendering time of the one or more layers is equal to a minimum rendering time threshold. The apparatus may also include means for monitoring a vertical synchronization (VSYNC) time period corresponding to the one or more layers when the rendering time of the one or more layers is greater than the maximum rendering time threshold. The apparatus may also include means for reducing the rendering resolution of the one or more layers when the VSYNC time period corresponding to the one or more layers is greater than a maximum VSYNC threshold.

The subject matter described herein can be implemented to realize one or more benefits or advantages. For instance, the described graphics processing techniques can be used by compositors, frame compositors, composers, hardware composers, frame composers, frame processors, display processors, DPUs, CPUs, GPUs, or other frame or graphics processors to enable the aforementioned adaptive rendering methods and processes. This can also be accomplished at a low cost compared to other frame or graphics processing techniques. Moreover, the frame or graphics processing techniques herein can improve or speed up data processing or execution. Further, the frame or graphics processing techniques herein can improve a CPU's or GPU's resource or data utilization and/or resource efficiency. Additionally, the frame or graphics processing techniques herein can include adaptive synchronization methods that can align a reduced display refresh rate with the display refresh rate of an application or game.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

1. A method of display processing, comprising:
monitoring a rendering time for each of a plurality of layers in a display frame;
determining whether a rendering time of one or more layers of the plurality of layers is greater than a maximum rendering time threshold; and
reducing a rendering resolution of the one or more layers when the rendering time of the one or more layers is greater than the maximum rendering time threshold, wherein the rendering resolution of the one or more layers is reduced until the rendering time of the one or more layers is equal to a minimum rendering time threshold and the rendering resolution of the one or more layers is reduced until the rendering resolution of the one or more layers is equal to a minimum resolution level.

2. (canceled)

3. (canceled)

4. The method of claim 1, further comprising:
increasing the rendering resolution of the one or more layers when the rendering time of the one or more layers is less than the minimum rendering time threshold.

5. (canceled)

6. The method of claim 1, further comprising:
increasing the rendering resolution of the one or more layers when the rendering resolution of the one or more layers is less than the minimum resolution level.

7. The method of claim 1, further comprising:
identifying the one or more layers when the rendering time of the one or more layers is greater than the maximum rendering time threshold.

8. The method of claim 1, further comprising:
stop adjusting the rendering resolution of the one or more layers when the rendering time of the one or more layers is equal to the minimum rendering time threshold.

9. The method of claim 1, further comprising:
monitoring a vertical synchronization (VSYNC) time period corresponding to the one or more layers when the rendering time of the one or more layers is greater than the maximum rendering time threshold.

10. The method of claim 9, further comprising:
reducing the rendering resolution of the one or more layers when the VSYNC time period corresponding to the one or more layers is greater than a maximum VSYNC threshold.

11. The method of claim 10, wherein the rendering resolution of the one or more layers is reduced until the VSYNC time period is less than the maximum VSYNC threshold.

12. The method of claim 9, wherein the VSYNC time period is equal to a difference between a first VSYNC time and a second VSYNC time.

13. The method of claim 9, wherein the VSYNC time period corresponds to the maximum rendering time threshold.

14. The method of claim 1, wherein an increase in a graphics processing unit (GPU) workload for the one or more layers corresponds to an increase in the rendering time of the one or more layers.

15. The method of claim 1, wherein the rendering resolution of the one or more layers corresponds to a window size of the one or more layers.

16. The method of claim 1, wherein the rendering resolution of the one or more layers is adjusted by a graphics processing unit (GPU).

17. An apparatus for display processing, comprising:
a memory; and
at least one processor coupled to the memory and configured to:
monitor a rendering time for each of a plurality of layers in a display frame;
determine whether a rendering time of one or more layers of the plurality of layers is greater than a maximum rendering time threshold; and
reduce a rendering resolution of the one or more layers when the rendering time of the one or more layers is greater than the maximum rendering time threshold, wherein the rendering resolution of the one or more layers is reduced until the rendering time of the one or more layers is equal to a minimum rendering time threshold and the rendering resolution of the one or more layers is reduced until the rendering resolution of the one or more layers is equal to a minimum resolution level.

18. (canceled)

19. (canceled)

20. The apparatus of claim 17, wherein the at least one processor is further configured to:
increase the rendering resolution of the one or more layers when the rendering time of the one or more layers is less than the minimum rendering time threshold.

21. (canceled)

22. The apparatus of claim 17, wherein the at least one processor is further configured to:
increase the rendering resolution of the one or more layers when the rendering resolution of the one or more layers is less than the minimum resolution level.

23. The apparatus of claim 17, wherein the at least one processor is further configured to:
identify the one or more layers when the rendering time of the one or more layers is greater than the maximum rendering time threshold.

24. The apparatus of claim 17, wherein the at least one processor is further configured to:
stop to adjust the rendering resolution of the one or more layers when the rendering time of the one or more layers is equal to the minimum rendering time threshold.

25. The apparatus of claim 17, wherein the at least one processor is further configured to:
monitor a vertical synchronization (VSYNC) time period corresponding to the one or more layers when the rendering time of the one or more layers is greater than the maximum rendering time threshold.

26. The apparatus of claim 25, wherein the at least one processor is further configured to:
reduce the rendering resolution of the one or more layers when the VSYNC time period corresponding to the one or more layers is greater than a maximum VSYNC threshold.

27. The apparatus of claim 26, wherein the rendering resolution of the one or more layers is reduced until the VSYNC time period is less than the maximum VSYNC threshold.

28. The apparatus of claim 25, wherein the VSYNC time period is equal to a difference between a first VSYNC time and a second VSYNC time, wherein the VSYNC time period corresponds to the maximum rendering time threshold.

29. An apparatus for display processing, comprising:
means for monitoring a rendering time for each of a plurality of layers in a display frame;
means for determining whether a rendering time of one or more layers of the plurality of layers is greater than a maximum rendering time threshold; and
means for reducing a rendering resolution of the one or more layers when the rendering time of the one or more layers is greater than the maximum rendering time threshold, wherein the rendering resolution of the one or more layers is reduced until the rendering time of the one or more layers is equal to a minimum rendering time threshold and the rendering resolution of the one or more layers is reduced until the rendering resolution of the one or more layers is equal to a minimum resolution level.

30. A non-transitory computer-readable medium storing computer executable code for display processing, comprising code to:
monitor a rendering time for each of a plurality of layers in a display frame;
determine whether a rendering time of one or more layers of the plurality of layers is greater than a maximum rendering time threshold; and
reduce a rendering resolution of the one or more layers when the rendering time of the one or more layers is greater than the maximum rendering time threshold, wherein the rendering resolution of the one or more layers is reduced until the rendering time of the one or more layers is equal to a minimum rendering time threshold and the rendering resolution of the one or more layers is reduced until the rendering resolution of the one or more layers is equal to a minimum resolution level.
